(19) United States
(12) Patent Application Publication
(10) Pub. No.: US 2026/0246319 A1
(43) Pub. Date: Aug. 20, 2026

(54) Laminated Core for an Electric Machine, in Particular of a Motor Vehicle, Electric Machine, and Motor Vehicle

(71) Applicant: Bayerische Motoren Werke Aktiengesellschaft, Muenchen (DE)

(72) Inventors: Anirudh JAIPURIA, Augsburg (DE); Jochen KRONSTEINER, St. Ulrich bei Steyr (AT); Andreas WAGNER, St. Valentin (AT)

(21) Appl. No.: 18/881,804

(22) PCT Filed: Aug. 29, 2023
(86) PCT No.: PCT/EP2023/073606

§ 371 Date: Jan. 7, 2025

(30) Foreign Application Priority Data
Aug. 31, 2022 (DE) 10 2022 121 996.8

(51) Int. Cl. H02K 1/20; H02K 1/16

(52) U.S. Cl. CPC H02K 1/20; H02K 1/16

(57) ABSTRACT

A laminated core for an electric machine, including at least three laminated core parts arranged in succession in the axial direction, specifically a first laminated core part which has at least two first temperature-control channels through which a temperature-control medium for controlling the temperature of the laminated core can flow, and a second laminated core part which axially adjoins a first axial end face of the first laminated core part and has at least one second temperature-control channel which is fluidically connected at least to the two first temperature-control channels and through which the temperature-control medium at least from the two first temperature-control channels can thus flow and which has a first flow cross section through which the temperature-control medium can flow.

### BACKGROUND AND SUMMARY

The invention relates to a laminated core for an electric machine, in particular of a motor vehicle. The invention also relates to an electric machine for a motor vehicle having at least one laminated core of this type. In addition, the invention also relates to a motor vehicle.

A method for the automated production of a winding of a stator of a rotating electric machine is known from EP 2 933 901 B1. DE 10 2008 064 495 B3 also discloses an electric machine. An electric machine is known from EP 3 324 517 A1. In addition, US 2021/0347245 A1 discloses a cooling system for an electric motor.

It is the object of the present invention to create a laminated core for an electric machine, in particular of a motor vehicle, an electric machine for a motor vehicle having at least one laminated core of this type, and a motor vehicle, such that particularly advantageous temperature control, i.e. cooling and/or heating, of the laminated core can be implemented in a particularly simple way.

This object is achieved according to the invention by a laminated core, by an electric machine, and by a motor vehicle having the features of the independent claims. Advantageous embodiments of the invention are the subject matter of the dependent claims.

A first aspect of the invention relates to a laminated core for an electric machine, in particular of a motor vehicle. This means for example that in the completely produced state, the motor vehicle, which is also simply called “vehicle” and which preferably is in the form of a car, in particular in the form of a passenger car, comprises the electric machine and can be driven electrically, in particular purely electrically, by means of the electric machine. The electric machine comprises the laminated core. The laminated core comprises at least three laminated core parts, which are arranged following one another and thus one behind the other in the axial direction of the laminated core and thus in the axial direction of the electric machine. When the laminated core is in its installed position, the axial direction of the laminated core coincides with the axial direction of the electric machine. In particular, the electric machine comprises a stator and a rotor, which can be driven by means of the stator and thereby can be rotated relative to the stator about a machine rotational axis. The axial direction of the electric machine and thus of the laminated core coincides with the machine rotational axis. The laminated core assumes its installed position in the completely produced state of the electric machine comprising the laminated core,

A first of the laminated core parts has at least two, in particular more than two, first temperature control channels, through which a preferably liquid temperature control medium can flow, in particular in the axial direction of the laminated core, for the temperature control, i.e. for the cooling and/or heating of the laminated core. By means of the temperature control medium, which for example is in the form of an oil and which can be part of the electric machine, the laminated core can be cooled, in particular by heat transfer from the laminated core to the temperature control medium. This occurs in particular when the temperature control medium has a lower temperature than the laminated core. In that case, the temperature control medium is used as a coolant, in particular as a cooling liquid, in order to cool the laminated core. It is also conceivable that the temperature control medium is used to beat the laminated core. In this case, heat is transferred from the temperature control medium to the laminated core, which occurs in particular when the temperature control medium has a higher temperature than the laminated core. The temperature control medium is, in particular, an oil. In particular, the temperature control medium can flow through each first temperature control channel along an associated first flow direction, the first flow direction preferably running in the axial direction of the laminated core and thus of the electric machine, therefore parallel to the axial direction of the laminated core.

In particular, the first laminated core part is formed by a plurality of mutually separate and mutually connected lamination parts, in particular individual laminations, which can be arranged following one another in the axial direction of the laminated core. The first laminated core part has a first axial end face. A second of the laminated core parts connects to the first axial end face of the first laminated core part axially, i.e. in the axial direction of the laminated core and thus of the electric machine. The second laminated core part has a second axial end face, which faces away from and therefore points away from the first end face of the first laminated core in the axial direction of the laminated core and thus of the electric machine. A third of the laminated cores connects to the second end face of the second laminated core axially, i.e. in the axial direction of the laminated core and thus of the electric machine. The second laminated core part has at least one, in particular more than one, second temperature control channel, which is fluidically connected at least to the two first temperature control channels of the first laminated core part and through which the temperature control medium consequently can flow at least from the two first temperature control channels. This means that the temperature control medium can, in particular first, flow through the first temperature control channels and flow out of the temperature control channels and at the same time flow into the second temperature control channel common to the first temperature control channels and consequently flow through the second temperature control channel. In particular, the temperature control medium can flow through the second temperature control channel in the axial direction of the laminated core. This means that, for example, the temperature control medium can flow through the second temperature control channel along a second flow direction, the second flow direction preferably running in the axial direction of the laminated core, therefore parallel to the axial direction of the laminated core. Because the second temperature control channel is fluidically connected to the second temperature control channels, the first temperature control channels are, as it were, merged into or to the second temperature control channel, so that the second laminated core part causes a channel merge or channel combination. In the channel combination, the first temperature control channels are merged into the second temperature control channel. Because the second temperature control channel runs in the second laminated core part, the mentioned channel combination is integrated into the second laminated core part and thus is an integrated channel combination. For example, the second laminated core part is formed by a plurality of mutually separate and mutually connected second lamination parts, in particular second individual laminations, which can be arranged following one another in the axial direction of the laminated core. Alternatively or additionally, the third laminated core part can, for example, be formed by a plurality of mutually separate and mutually connected third lamination parts, in particular individual laminations, which can be arranged following one another in the axial direction of the laminated core. When the axial direction or “axially” is mentioned below, this should be understood to mean, unless otherwise specified, the axial direction of the laminated core and thus of the electric machine.

The second temperature control channel has a first flow cross section through which the temperature control medium can flow, through which first flow cross section the temperature control medium can flow in particular along or into the second flow direction.

The third laminated core part, which axially connects to the second end face of the second laminated core part, has a third temperature control channel, which is fluidically connected to the second temperature control channel and through which the temperature control medium consequently can flow from the second temperature control channel and which has a second flow cross section smaller than the first flow cross section. In particular, the temperature control medium can flow through the third temperature control channel in the axial direction of the laminated core. In other words, for example, the temperature control medium can flow through the third temperature control channel along a third flow direction, the third flow direction preferably running in the axial direction of the laminated core, therefore parallel to the axial direction of the laminated core. In particular, for each second temperature control channel of the second laminated core part, one, in particular exactly one, associated third temperature control channel of the third laminated core part is provided, the second temperature control channel being fluidically connected to the associated third temperature control channel so that the temperature control medium, in particular the same temperature control medium, can flow through the second temperature control channel and the third temperature control channel. The third temperature control channel has a second flow cross section smaller than the first flow cross section so that a flow cross section narrowing or flow cross section constriction or flow cross section reduction is formed or caused by the third temperature control channel or by the third laminated core part. This results in jet formation, in which a spray jet is formed from the temperature control medium by means of the third temperature control channel or by means of the third flow cross section, which spray jet is also simply called “jet” and is formed by the temperature control medium flowing through the third temperature control channel and, for example, can be or is sprayed out of the laminated core as a whole to surroundings of the laminated core, in particular during operation of the electric machine. It can be seen that the second temperature control channel bundles, and therefore merges, the first temperature control channels and thus the temperature control medium, for example in the form of an oil, flowing through the first temperature control channels, the third temperature control channel forming the mentioned spray jet from the temperature control medium flowing through the second temperature control channel and the third temperature control channel, which spray jet is sprayed out of the laminated core to its surroundings via the third temperature control channel. For example, the spray jet sprayed out of the laminated core is sprayed against a portion of at least one winding of the electric machine which is supported by the laminated core. In particular, the portion can be a winding overhang of the winding, the winding overhang of which is particularly advantageously wetted with the temperature control medium as a result of the spraying of the spray jet against the winding overhang. As a result, the winding overhang can be particularly advantageously temperature-controlled. Overall, the laminated core allows particularly advantageous guiding of the temperature control medium and advantageous provision of the spray jet, so that additional components for guiding the temperature control medium and for forming the spray jet can be avoided. Thus, a particularly simple and thus time-efficient and economical production or assembly of the laminated core and of the electric machine can be implemented.

In particular, the third temperature control channel opens out at a fourth axial end face of the third laminated core part, the fourth axial end face of which faces away from and therefore points away from the first axial end face and from the second axial end face in the axial direction of the laminated core.

In order to be able to implement particularly advantageous temperature control, each temperature control channel preferably is formed in particular all around, along its associated peripheral direction, and directly by the associated laminated core part. The peripheral direction of each temperature control channel runs around the associated flow direction along which the temperature control medium can flow or flows through the particular temperature control channel.

The second laminated core part connects to the first laminated core part in a connecting direction running in the axial direction of the laminated core, and the third laminated core part connects to the second laminated core part in the connecting direction. With respect to the connecting direction, the third laminated core part is preferably the last laminated core part of the laminated core, which terminates the laminated core, and as a result particularly advantageous jet formation and therefore temperature control can be implemented.

The first laminated core part has a third axial end face, which faces away from and therefore points away from the first axial end face and from the second axial end face and also from the fourth axial end face in the axial direction.

In order to be able to implement particularly simple and thus economical supply of the temperature control medium to the temperature control channels and consequently particularly advantageous temperature control, in one embodiment of the invention the laminated core comprises a fourth laminated core part, which connects to the third axial end face of the first laminated core part axially, therefore in the axial direction of the laminated core, and which has a fourth temperature control channel fluidically connected to one of the first temperature control channels and a fifth temperature control channel fluidically connected to the other of the first temperature control channels. The fourth temperature control channel and the fifth temperature control channel each have an inlet opening which extends in the radial direction or obliquely to the radial direction of the laminated core and thus of the electric machine and through which the preferably liquid temperature control medium can be introduced, in the radial direction or along a direction running obliquely to the radial direction of the laminated core and thus of the electric machine, from outside the laminated core into the fourth temperature control channel and the fifth temperature control channel. When “radially” or “radial direction” is mentioned, this should be understood to mean, unless otherwise specified, the radial direction of the laminated core and thus of the electric machine running perpendicularly to the radial direction of the laminated core and thus of the electric machine. This embodiment allows particularly simple and advantageous introduction of the temperature control medium into the fourth temperature control channel and the fifth temperature control channel and, through them, into the other temperature control channels of the laminated core. The preceding and following statements regarding each first temperature control channel, regarding the second temperature control channel, and regarding the third temperature control channel can readily be applied also to the fourth temperature control channel and to the fifth temperature control channel, and vice versa.

Another embodiment is characterized in that the laminated core parts are produced separately and independently of one another and arranged one against the other in the axial direction of the laminated core and thus assembled. As a result, a particularly simple and economical design of the laminated core can be implemented, so that particularly effective and efficient cooling can be provided in a simple and economical way.

For example, the fourth laminated core part is formed or assembled from a plurality of mutually separate and mutually connected fourth lamination parts, in particular individual laminations, which for example are arranged following one another in the axial direction. It is conceivable that each lamination part is of a single-piece design and therefore is formed by a single piece. In other words, each lamination part is preferably not assembled from a plurality of mutually separate and mutually connected parts, but rather each lamination part is preferably formed by a single piece and therefore is formed by a monoblock or is in the form of a monoblock.

In another, particularly advantageous embodiment of the invention, the first laminated core part has a plurality of teeth for supporting the previously mentioned winding, the teeth following one another in a peripheral direction of the laminated core which runs around the axial direction of the laminated core. In particular, the winding has first length regions by means of which the winding is held on the teeth. Second length regions of the winding protrude, for example, from the laminated core in the axial direction of the laminated core and form, for example, the previously mentioned winding overhang. In particular when the laminated core is part of the stator of the electric machine, the teeth are also called “stator teeth”. It is also provided that the first laminated core part has a plurality of slots for leading the winding through, the slots following one another in a peripheral direction of the laminated core which runs around the axial direction of the laminated core and being arranged between the teeth. In other words, for example in the completely produced state of the electric machine, the winding, in particular the first length regions, is led through the slots, in particular in the axial direction.

The first temperature control channels of the first laminated core are channels or also simply called “channels”. In order to be able to implement particularly effective and efficient temperature control, in another embodiment of the invention a first of the channels is associated with one of the teeth, wherein is overlapped in the radial direction of the laminated core and thus of the electric machine outward at least partially by the associated first channel. Thus, the one tooth can be particularly advantageously temperature-controlled. The preceding and following statements regarding the one tooth can readily be applied also to the other teeth, and vice versa.

It is also preferably provided that the second channel is associated with one of the slots, the one slot being overlapped in the radial direction of the laminated core outward at least partially by the associated second channel. As a result, the one slot and thus that first length region of the winding that is arranged in the one slot can be effectively and efficiently temperature-controlled. The preceding and following statements regarding the one slot can readily be applied also to the other slots, and vice versa.

Another embodiment is characterized in that the first channel has a flow cross section which is elongate in the radial direction and through which the temperature control medium can flow. In other words, the first channel is preferably in the form of a slit, the longitudinal extent or direction of longitudinal extent of which runs in the radial direction of the laminated core. Thus, particularly advantageous temperature control of the tooth can be implemented.

In order to allow particularly advantageous temperature control of the slot, in another embodiment of the invention the second channel has a flow cross section which is elongate in the peripheral direction of the laminated core and through which the temperature control medium can flow. In other words, the second channel is preferably a slit, the longitudinal extent or direction of extent of which runs in the peripheral direction of the laminated core. Thus, the slot can be particularly effectively and efficiently temperature-controlled.

The first flow cross section and/or the second flow cross section are preferably circular, whereby particularly advantageous formation of the spray jet can be implemented. The slots and the teeth of the first laminated core part form a slot pattern or are part of a slot pattern which, for example, is also provided in the second laminated core part, in the third laminated core part, and/or in the fourth laminated core part. Therefore, the preceding and following statements regarding the first laminated core part with respect to the slots and the teeth can be applied also to the second laminated core part, the third laminated core part, and the fourth laminated core part. For example, the statements regarding the first channel of the first laminated core part can be applied also to the fourth temperature control channel, which for example is fluidically connected to the first channel. Furthermore, for example the preceding statements regarding the second channel can be applied to the fifth temperature control channel, which for example is fluidically connected to the second channel. Thus, particularly advantageous guiding of the temperature control medium and consequently particularly advantageous temperature control can be provided.

A second aspect of the invention relates to an electric machine for a motor vehicle, the electric machine comprising at least one laminated core according to the first aspect of the invention. Advantages and advantageous embodiments of the first aspect of the invention are to be regarded as advantages and advantageous embodiments of the second aspect of the invention, and vice versa.

In a particularly advantageous embodiment of the second aspect of the invention, the electric machine comprises the stator and the rotor, the laminated core being a laminated core of the stator, therefore a stator laminated core. Thus, particularly advantageous temperature control of the electric machine can be provided.

A third aspect of the invention relates to a motor vehicle which preferably is in the form of a car, in particular in the form of a passenger car, and which comprises at least one electric machine according to the second aspect of the invention and can be driven electrically, in particular purely electrically, by means of the electric machine. Advantages and advantageous embodiments of the first aspect and of the second aspect of the invention are to be regarded as advantages and advantageous embodiments of the third aspect of the invention, and vice versa.

Additional details of the invention result from the following description of a preferred exemplary embodiment with the associated drawings. In the drawings:

### BRIEF DESCRIPTION OF THE DRAWINGS

FIG. 1 shows a schematic and perspective exploded view of a laminated core for an electric machine of a motor vehicle;

FIG. 2 shows part of the laminated core in a schematic perspective view;

FIG. 3 shows part of the laminated core in another schematic perspective view;

FIG. 4 shows part of the laminated core in another schematic perspective view; and

FIG. 5 shows part of the laminated core in another schematic perspective view.

### DETAILED DESCRIPTION OF THE DRAWINGS

In the figures, similar or functionally similar elements are given the same reference signs.

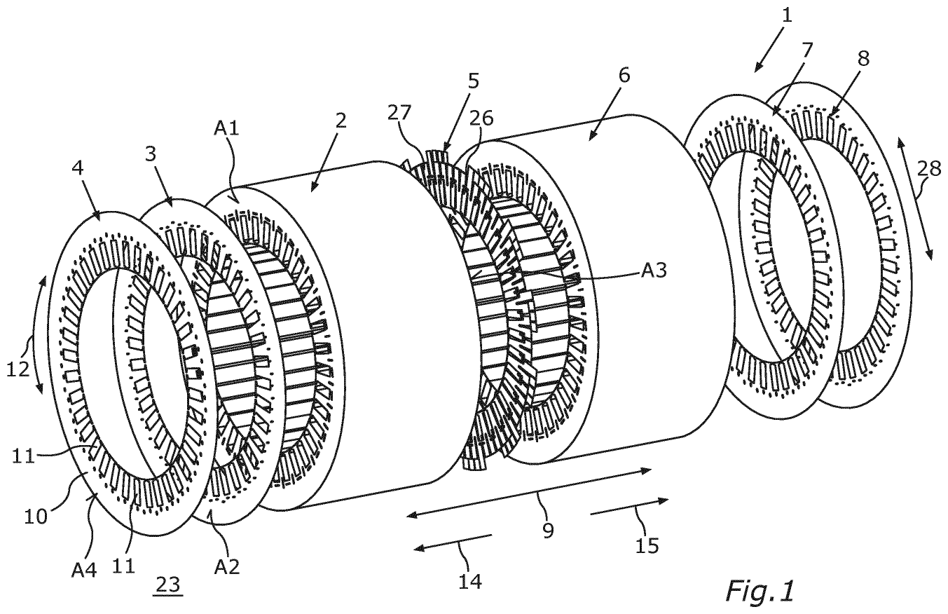

FIG. 1 shows, in a schematic and perspective exploded view, a laminated core 1 for an electric machine of a motor vehicle, which is also simply called “vehicle”.

This means that the motor vehicle, in its completely produced state, comprises the electric machine and can be driven electrically, in particular purely electrically, by means of the electric machine. The electric machine comprises a stator and a rotor, which can be driven by means of the stator and thereby can be rotated relative to the stator about a machine rotational axis. By means of its rotor, the electric machine can provide drive torques for driving the motor vehicle. Therefore, the motor vehicle is, for example, a hybrid vehicle or an electric vehicle, in particular a battery electric vehicle (BEV). The electric machine is preferably a high-voltage component, the voltage, in particular operating or nominal voltage, of which is preferably greater than 50 volts, in particular greater than 60 volts, and very preferably several hundred volts.

The laminated core 1 is preferably part of the stator and thus is a stator laminated core. The laminated core 1 comprises, in the present case exactly, seven laminated core parts, namely a first laminated core part 2, a second laminated core part 3, a third laminated core part 4, a fourth laminated core part 5, a fifth laminated core part 6, a sixth laminated core part 7, and a seventh laminated core part 8. The laminated core parts 2 and 6 are preferably identical, and therefore structurally the same. The laminated core parts 3 and 7 are preferably identical, and therefore structurally the same. Furthermore, the laminated core parts 4 and 8 are preferably identical, and therefore structurally the same. It is clear that the laminated core parts 2, 3, 4, 5, 6, 7 and 8 are arranged following one another, therefore one behind the other, in the axial direction of the laminated core 1 and thus of the electric machine, the axial direction of which coincides with the axial direction of the laminated core 1 and with the machine rotational axis. The axial direction of the laminated core 1 and thus of the electric machine is illustrated by a double arrow 9. It is clear that the laminated core parts 4 and 8 are the last laminated core parts of the laminated core 1 in the axial direction of the laminated core 1. It is also clear that the laminated core part 2 is arranged between the laminated core parts 3 and 5 in the axial direction and the laminated core part 3 is arranged between the laminated core parts 2 and 4 in the axial direction. The laminated core part 5 is arranged between the laminated core parts 2 and 6 in the axial direction, the laminated core part 6 is arranged between the laminated core parts 5 and 7 in the axial direction, and the laminated core part 7 is arranged between the laminated core parts 6 and 8 in the axial direction. In particular, the laminated core part 5 is arranged exactly in the center of the laminated core 1 in the axial direction of the laminated core 1, and therefore the laminated core part 5 is also called “center part”.

It is particularly clear from FIG. 1, using the laminated core part 4 as an example, that each laminated core part 2, 3, 4, 5, 6, 7, 8 has a plurality of teeth 10, also called “stator teeth”, which follow one another in a peripheral direction running around the axial direction of the laminated core 1, and a plurality of slots 11, also called “stator slots”, which follow one another in the peripheral direction of the laminated core 1 and are arranged between the teeth 10. The peripheral direction of the laminated core 1 is illustrated by a double arrow 12 and runs around the axial direction of the laminated core 1. In the completely produced state of the electric machine, at least one winding of the electric machine, also called “stator winding”, is held on the laminated core 1, in particular in that the winding is held on the laminated core 1 by means of first length regions of the winding. The first length regions extend, for example, in the axial direction of the laminated core 1 and are led through the slots 11. Respective second length regions of the winding protrude, in the axial direction of the laminated core 1, from the laminated core 1 and thus from the last laminated core parts 4 and 8, whereby the second length regions form at least one winding overhang of the at least one winding. The winding overhang protruding, in the axial direction of the laminated core 1, from the laminated core part 4 which is last in the axial direction is clear from FIG. 3 and is labeled with 13 there. It is also clear from FIG. 1 that the laminated core part 3 connects to the laminated core part 2 in a first connecting direction which runs in the axial direction and which is illustrated by an arrow 14, and the laminated core part 4 connects to the laminated core part 3 in the first connecting direction, and the laminated core part 2 connects to the laminated core part 5 in the first connecting direction. The laminated core part 5 connects to the laminated core part 2 in a second connecting direction which runs in the axial direction and which is opposite to the first connecting direction and which is illustrated by an arrow 15, and the laminated core part 6 connects to the laminated core part 5 in the second connecting direction, and the laminated core part 7 connects to the laminated core part 6 in the second connecting direction, and the laminated core part 8 connects to the laminated core part 7 in the second connecting direction.

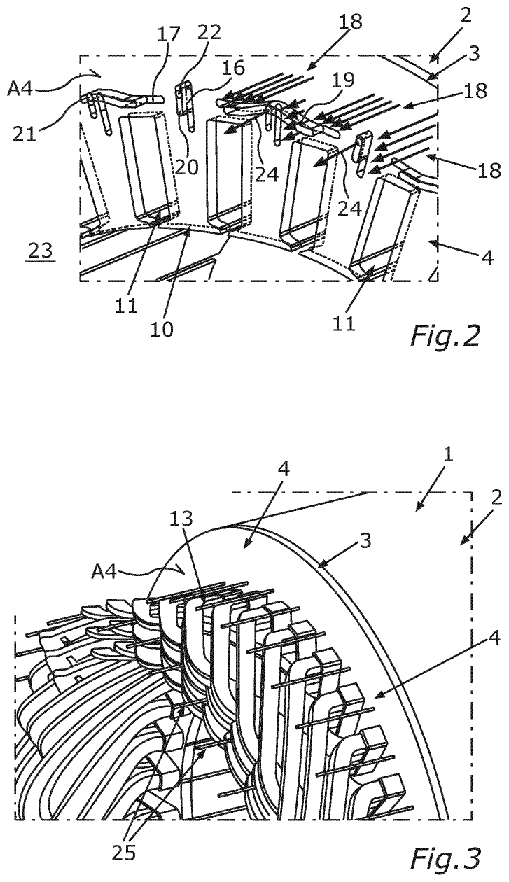

It is clear from FIG. 2 that each of the laminated core parts 2, 6 has a plurality of first temperature control channels 16 and 17, the first temperature control channels 16 also being called “first channels” and the first temperature control channels 17 also being called “second channels”. A preferably liquid temperature control medium can flow through the temperature control channels 16 and 17 for the temperature control, i.e. for the cooling and/or heating of the laminated core 1.

The laminated core part 2 has a first axial end face A1, and the laminated core part 3 connects to the axial end face A1 in the axial direction of the laminated core 1. The laminated core part 3 has a second axial end face A2, and the laminated core part 4 connects to the axial end face A2 axially, i.e. in the axial direction of the laminated core 1. In FIG. 2, arrows 18 illustrate respective flows of the temperature control medium through the temperature control channels 16 and 17. It is clear that the laminated core part 3 has second temperature control channels 19 and 20. The temperature control channels 19 are also called, for example, “third channels”, and the temperature control channels 20 are also called, for example, “fourth channels”. It is clear from FIG. 2 that each of the temperature control channels 19 is fluidically connected to at least two, in particular to at least or exactly three, of the first temperature control channels 16 and 17 of the first laminated core part 2, in the present case in such a way that each of the temperature control channels 19 is connected fluidically to at least or exactly two of the temperature control channels 17 and to at least or exactly one of the temperature control channels 16. As a result, in each case two of the temperature control channels 17 and one of the temperature control channels 16 are merged, therefore bundled, into, in particular exactly, one of the temperature control channels 19, so that the laminated core part 3 causes a channel bundling or channel merging. It is also clear that, for example, each temperature control channel 20 is fluidically connected to, in particularly exactly, one of the temperature control channels 16.

Each temperature control channel 16, 17 has a first flow cross section through which the temperature control medium can flow.

The laminated core part 4 has third temperature control channels 21 and 22, each of the temperature control channels 21 being fluidically connected to one of the temperature control channels 19 and each of the temperature control channels 22 being fluidically connected to one of the temperature control channels 20. Each temperature control channel 20, 21 has a second flow cross section, which is smaller than the associated first flow cross section. Thus, the laminated core part 4 causes a cross section narrowing or cross section constriction. As a result, the temperature control medium can flow through the temperature control channels 16, 17, 19, 20, 21 and 22, and respective spray jets, also simply called “jets”, are formed from the temperature control medium flowing through the temperature control channels 21 and 22 by means of the temperature control channels 21 and 22, the spray jets being sprayed out of the laminated core 1 as a whole via the temperature control channels 21 and 22 and thus sprayed to surroundings 23 of the laminated core 1. In FIG. 2, arrows 24 illustrate the spray jets, which flow out of the temperature control channels 21 and 22 and are thereby sprayed to the surroundings 23. It is clear that the second flow cross section of each temperature control channel 21, 22 is circular, whereby the associated spray jet is formed particularly advantageously.

The spray jets are shown particularly schematically in FIG. 3 and are labeled with 25. It is clear from FIG. 3 that the spray jets 25 are sprayed against the winding overhang 13, which is thus wetted with the temperature control medium forming the spray jets 25. As a result, the winding overhang 13 is effectively and efficiently temperature-controlled.

The laminated core part 4 has a fourth axial end face A4, which points away from and therefore faces away from the end faces A1 and A2 in the axial direction. It is clear from FIG. 2 that the temperature control channels 21 and 22 open out at the axial end face A4 into or to the surroundings 23, so that the spray jets 25 are sprayed out of the laminated core 1 as a whole at the fourth axial end face A4.

It is clear from FIG. 2 that the temperature control channels 16 and 17 fluidically connected to the temperature control channel 19 are in particular mutually spaced apart in the peripheral direction of the laminated core 1. Therefore, a flow deflection occurs, in which the temperature control medium is deflected, on its way from the temperature control channels 16 and 17 fluidically connected to the temperature control channel 19, to and into the temperature control channel 19. This flow deflection occurs at the channel combination, in which the two temperature control channels 17 and the one temperature control channel 16 are merged or combined, and therefore bundled, into the temperature control channel 19.

The first laminated core part 2 has a third axial end face A3, which points away from and therefore faces away from the axial end faces A1 and A2 and also from the axial end face A4 in the axial direction. The fourth laminated core part 5 connects to the third axial end face A3 of the first laminated core part 2 in the second connecting direction and thus in the axial direction of the laminated core 1.

For example, the laminated core part 5 has, for each temperature control channel 16 of the laminated core part 2, one, in particular exactly one, fourth temperature control channel 26 and, for each temperature control channel 17 of the laminated core part 2, one, in particular exactly one, fifth temperature control channel 27. Each temperature control channel 26 is fluidically connected to the associated temperature control channel 16, and each temperature control channel 27 is fluidically connected to the associated temperature control channel 17. Thus, the temperature control channels 16 can be supplied with the temperature control medium by means of the temperature control channels 26, and the temperature control channels 17 can be supplied with the temperature control medium by means of the temperature control channels 27. Each temperature control channel 26, 27 has a respective inlet opening which extends in the radial direction of the laminated core 1 or obliquely to the radial direction of the laminated core 1. The radial direction of the laminated core 1 is illustrated by a double arrow 28. The feature according to which each inlet opening extends in the radial direction of the laminated core 1, the radial direction of which runs in the radial direction of the electric machine, is to be understood to mean that the temperature control medium can be introduced from outside the laminated core 1 and thus from the surroundings 23 in the radial direction of the laminated core 1 or along a direction running obliquely to the radial direction of the laminated core 1 through each inlet opening and thus into the associated temperature control channel 26, 27, so that the temperature control channels of the laminated cores 2, 3, 4, 6, 7 and 8 can be supplied with the temperature control medium via the center part (laminated core part 5). In other words, the temperature control medium can be introduced into the center part in the radial direction or in the direction running obliquely to the radial direction and can be distributed by means of the center part to the temperature control channels of the other laminated core parts 2, 3, 4, 6, 7 and 8.

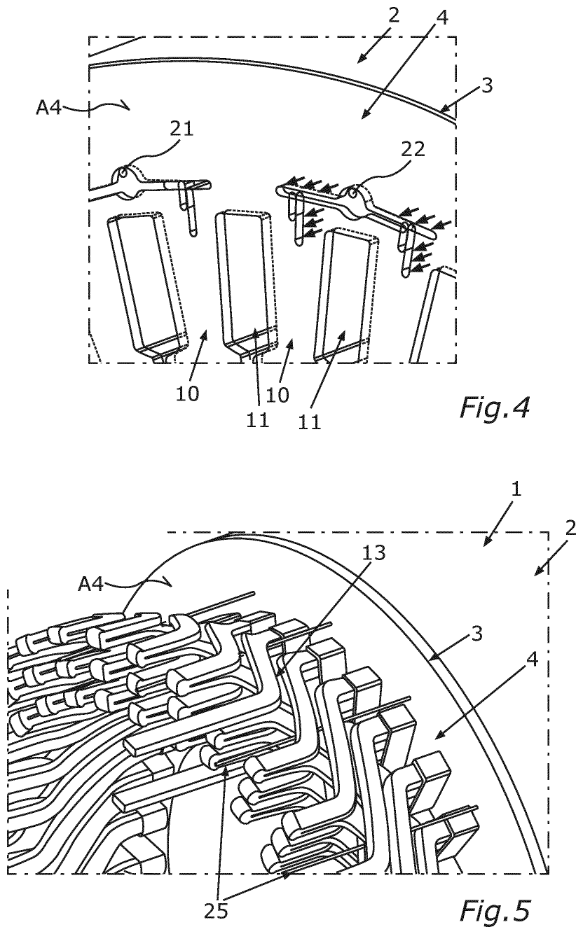

The temperature control channels 21 and 22 of the laminated core part 4 are also particularly clear from FIG. 4. In addition, the teeth 10 and the slots 11 arranged between the teeth are particularly clear from FIG. 4. The spray jets 25 are also illustrated in FIG. 5.

As is clear from FIGS. 2 and 4, each temperature control channel 16 has a flow cross section which is elongate in the radial direction of the laminated core 1 and through which the temperature control medium can flow and by which the associated tooth 10 is overlapped in the radial direction outward at least partially. Thus, the teeth 10 can be temperature-controlled particularly well. Each temperature control channel 17 has a flow cross section which is elongate in the peripheral direction of the laminated core 1 and through which the temperature control medium can flow and by which the associated slot 11 is overlapped in the radial direction of the laminated core 1 outward at least partially. Thus, the slots 11 and the first length regions of the windings which run therein can be temperature-controlled particularly advantageously.

### LIST OF REFERENCE SIGNS

1 Laminated core
2 First laminated core part
3 Second laminated core part
4 Third laminated core part
5 Fourth laminated core part
6 Laminated core part
7 Laminated core part
8 Laminated core part
9 Double arrow
10 Tooth
11 Slot
12 Double arrow
13 Winding overhang
14 Arrow
15 Arrow
16 Temperature control channel
17 Temperature control channel
18 Arrow
19 Temperature control channel
20 Temperature control channel
21 Temperature control channel
22 Temperature control channel
23 Surroundings
24 Arrow
25 Spray jet
26 Temperature control channel
27 Temperature control channel
28 Double arrow
A1 First axial end face
A2 Second axial end face
A3 Third axial end face
A4 Fourth axial end face

1.-10. (canceled)

11. A laminated core for an electric machine, the laminated core comprising:
at least three laminated core parts arranged following one another in an axial direction, the at least three laminated cote parts including:
a first laminated core part including at least two first temperature control channels, through which a temperature control medium can flow for the temperature control of the laminated core;
a second laminated core part configured to connect to a first axial end face of the first laminated core part axially, the second laminated core part including at least one second temperature control channel, which is fluidically connected to the at least two first temperature control channels and through which the temperature control medium is flowable at least from the at least two first temperature control channels and which has a first flow cross section through which the temperature control medium is flowable; and
a third laminated core part configured to axially connect to a second axial end face of the second laminated core part facing away, in the axial direction, from the first end face and which has a third temperature control channel, which is fluidically connected to the second temperature control channel and through which the temperature control medium is flowable from the second temperature control channel and which has a second flow cross section smaller than the first flow cross section.

12. The laminated core according to claim 11, wherein a fourth laminated core part, configured to connect axially to a third axial end face of the first laminated core part facing away, in the axial direction, from the first end face and from the second end face, the fourth laminated core part including a fourth temperature control channel fluidically connected to one of the first temperature control channels and a fifth temperature control channel fluidically connected to another of the first temperature control channels, wherein the fourth temperature control channel and the fifth temperature control channel each have an inlet opening which extends in a radial direction or obliquely to the radial direction and through which the temperature control medium is introducible, in the radial direction or along a direction running obliquely to the radial direction, from outside the laminated core into the fourth temperature control channel and the fifth temperature control channel.

13. The laminated core according to claim 11, wherein the laminated core parts are produced separately and independently of one another and arranged one against another in the axial direction.

14. The laminated core according to claim 12, wherein the laminated core parts are produced separately and independently of one another and arranged one against another in the axial direction.

15. The laminated core according to claim 11, wherein the first laminated core part has a plurality of teeth configured to support at least one winding, the teeth following one another in a peripheral direction of the laminated core, and a plurality of slots configured to feed the winding through, the slots following one another in the peripheral direction of the laminated core and being arranged between the teeth.

16. The laminated core according to claim 12, wherein the first laminated core part has a plurality of teeth configured to support at least one winding, the teeth following one another in a peripheral direction of the laminated core, and a plurality of slots configured to feed the winding through, the slots following one another in the peripheral direction of the laminated core and being arranged between the teeth.

17. The laminated core according to claim 16, wherein the first temperature control channels are channels in which:
a first channel of the channels is associated with one of the teeth and is overlapped in the radial direction outward at least partially by the one of the teeth; and
a second channel of the channels is associated with one of the slots and is overlapped in the radial direction outward at least partially by the one of the slots.

18. The laminated core according to claim 17, wherein the first channel bas a flow cross section which is elongate in the radial direction and through which the temperature control medium is flowable.

19. The laminated core according to claim 17, wherein the second channel has a flow cross section which is elongated in the peripheral direction of the laminated core and through which the temperature control medium is flowable.

20. The laminated core according to claim 18, wherein the second channel has a flow cross section which is elongated in the peripheral direction of the laminated core and through which the temperature control medium is flowable.

21. An electric machine for a motor vehicle, comprising a laminated core for an electric machine, the laminated core comprising:
at least three laminated core parts arranged following one another in an axial direction, the at least three laminated cote parts including:
a first laminated core part including at least two first temperature control channels, through which a temperature control medium can flow for the temperature control of the laminated core;
a second laminated core part configured to connect to a first axial end face of the first laminated core part axially, the second laminated core part including at least one second temperature control channel, which is fluidically connected to the at least two first temperature control channels and through which the temperature control medium is flowable at least from the at least two first temperature control channels and which has a first flow cross section through which the temperature control medium is flowable; and
a third laminated core part configured to axially connect to a second axial end face of the second laminated core part facing away, in the axial direction, from the first end face and which has a third temperature control channel, which is fluidically connected to the second temperature control channel and through which the temperature control medium is flowable from the second temperature control channel and which has a second flow cross section smaller than the first flow cross section.

22. The electric machine according to claim 21, wherein the electric machine comprises a stator and a rotor, and the stator includes the laminated core.

23. A motor vehicle comprising at least one electric machine according to claim 21.
